(19) United States
(12) Patent Application Publication
(10) Pub. No.: US 2026/0309548 A1
(43) Pub. Date: Oct. 8, 2026

(54) METHOD AND APPARATUS FOR SEGMENTED SPECTRAL MEASUREMENT USING OD FILTERS FOR NVIS RADIANCE CALCULATION

(71) Applicant: Novanta Corporation, Bedford, MA (US)

(72) Inventors: Matthew Falanga, Liverpool, NY (US); Qing Gu, Manlius, NY (US)

(73) Assignee: Novanta Corporation, Bedford, MA (US)

(21) Appl. No.: 19/635,997

(22) Filed: Apr. 1, 2026

Related U.S. Application Data
(60) Provisional application No. 63/784,648, filed on Apr. 7, 2025.
(60) Provisional application No. 63/869,656, filed on Aug. 25, 2025.

(51) Int. Cl. G01J 3/51; G01J 3/46; G01J 3/50

(52) U.S. Cl. CPC G01J 3/51; G01J 3/461; G01J 3/462; G01J 3/502

(57) ABSTRACT

A method for calculating NVIS radiance via segmented spectral measurement using a sequence of several OD filters to enhance dynamic range utilization and ensure compliance with MIL-STD-3009 by normalizing, stitching, and integrating spectral data in a tailored fashion. The method may be implemented on a calibration device having a spectroradiometer coupled to an imaging photometer or colorimeter. The common optical path includes a turret with a filter wheel and a beamsplitter that can divide the incoming light to an imaging assembly of the imager having a cooled CMOS imager and to the entry port of an adjacently positioned spectroradiometer. The filter wheel may be rotated to sequentially present the sequence of OD filters with the resulting images stitched together and processed to provide a full spectrum from which total NVIS radiance can be determined.

### CROSS-REFERENCE TO RELATED APPLICATIONS

The present application claims priority to U.S. Provisional App. No. 63/784,648 filed on Apr. 7, 2025, and U.S. Provisional App. No. 63/869,656 filed on Aug. 25, 2025.

### BACKGROUND OF THE INVENTION

### 1. Field of the Invention

The present disclosure relates to vision calibration systems and, more specifically, to a method for measuring night vision imaging system (NVIS) radiance using spectral segmentation and variable optical density (OD) filters.

### 2. Description of the Related Art

A Pritchard® photometer is a highly precise instrument used to measure light intensity, color, and other photometric properties using a Pritchard optical system. For example, a Pritchard photometer may be used to perform compliance testing of specialty vision systems, such as night vision googles. As the quality of vision systems improve, there is a need for even more precise measurements when performing compliance testing. Accordingly, there is a need in the art for a device that can combine photometric, colorimetric and spectroradiometric imaging for improved calibration testing.

For example, night vision compatibility of illuminated devices must comply with MIL-STD-3009, and thus requires precise measurement of NVIS radiance. Conventional spectrometers face dynamic range limitations when measuring across a wide spectral span (450-930 nm). A need therefore exists for an improved method that balances spectral sensitivity, avoids saturation, and conforms to standard radiometric evaluation procedures.

### BRIEF SUMMARY OF THE INVENTION

The present invention is a method to measure NVIS radiance by segmenting the spectral range and applying different OD filters to each region based on intensity. The resulting spectra are normalized, stitched, and integrated to compute accurate NVIS radiance that complies with MIL-STD-3009. The method may be implemented on a combined photometric, colorimetric and spectroradiometric imaging device that includes spectroradiometer coupled to an imaging photometer or colorimeter. The imaging photometer includes a turret with a filter wheel for sequentially presented the different OD filters and a beamsplitter that can divide the optical path between a cooled CMOS imaging assembly of the imaging photometer and the entry port of an adjacently positioned spectroradiometer.

### BRIEF DESCRIPTION OF THE SEVERAL VIEWS OF THE DRAWING(S)

The present invention will be more fully understood and appreciated by reading the following Detailed Description in conjunction with the accompanying drawings, in which:

FIG. 1 is a perspective view of a combined photometric, colorimetric and spectroradiometric device having an imaging photometer coupled to a spectroradiometer according to the present invention.

FIG. 2 is a perspective view of a combined photometric, colorimetric and spectroradiometric device according to the present invention with the housing of the imaging photometer removed.

FIG. 3 is a front view of a combined photometric, colorimetric and spectroradiometric device according to the present invention.

FIG. 4 is another perspective view of a combined photometric, colorimetric and spectroradiometric device according to the present invention with the housing of the imaging photometer removed.

FIG. 5 is a further perspective view of a combined photometric, colorimetric and spectroradiometric device according to the present invention with the housing of the imaging photometer removed.

FIG. 6 is a top view of a combined photometric, colorimetric and spectroradiometric device according to the present invention with the housing of the imaging photometer removed.

FIG. 7 is a graph of a high dynamic range measurement of a combined photometric, colorimetric and spectroradiometric device according to the present invention, where a NVIS Class A relative response is applied to input radiance with units of W/(m²-sr-nm).

FIG. 8 is a perspective view of the common optical pathway of the calibration device according to the present invention.

FIG. 9 is a perspective view of a thermoelectric cooler (TEC) and heat sink of an imaging assembly according to the present invention.

FIG. 10 is a perspective view of an imager sensor, TEC, heat sink, and photopic filter according to the present invention.

FIG. 11 is a perspective view of a housing enclosing an imager sensor, TEC, heat sink, and photopic filter according to the present invention.

FIG. 12 is a schematic of a control system for a combined photometric, colorimetric and spectroradiometric device according to the present invention.

FIG. 13 is a Venn diagram of the various applications of a combined photometric, colorimetric and spectroradiometric device according to the present invention.

FIG. 14 is an exemplary GA (2) curve for Class A NVIS overlaid with OD filter segments according to the present invention.

FIG. 15 is a flowchart of a method for determining NVIS radiance according to the present invention.

### DETAILED DESCRIPTION OF THE INVENTION

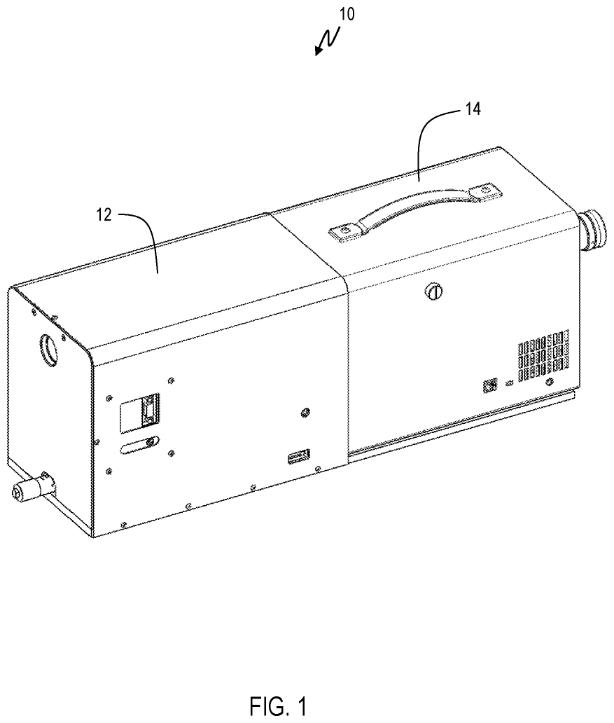

Referring to the figures, wherein like numerals refer to like parts throughout, there is seen in FIG. 1, a device 10 that combines imaging and spectroradiometric analyses according to the present invention. Device 10 includes an imager 12 (such as an imaging photometer or colorimeter) and a spectroradiometer 14 that are coupled together for simultaneously collecting data about an optical system to be tested or calibrated. Imaging may comprise photometric or colorimetric measurements so references herein to imager 12 should be understood as encompass both photometric imagers and colorimeters.

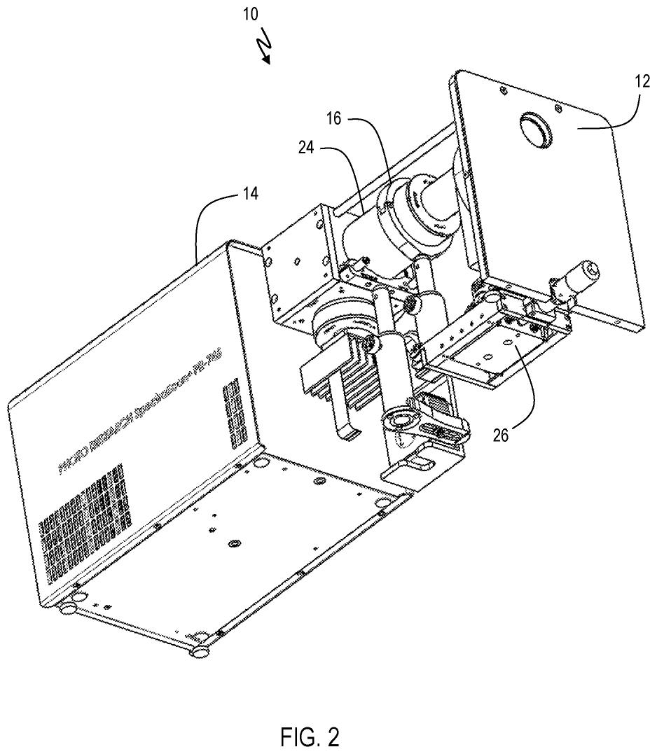

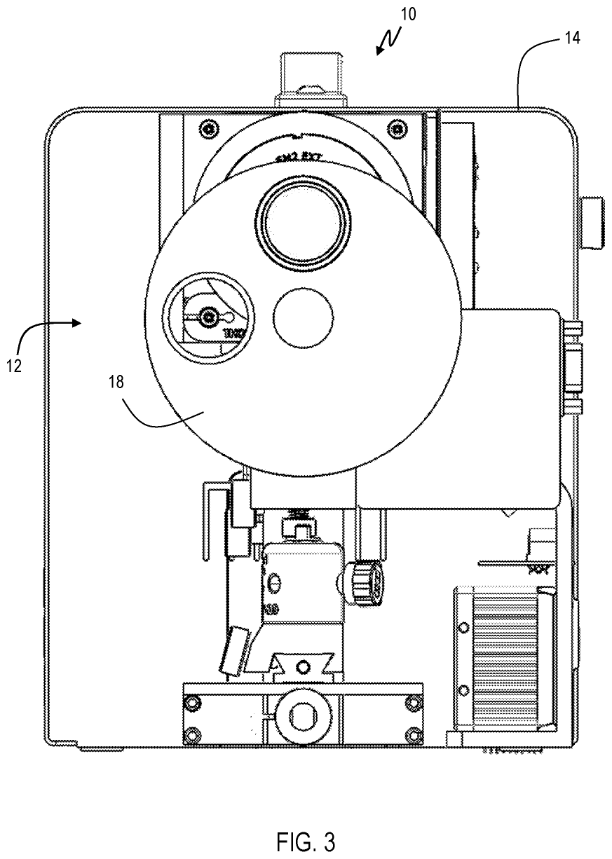

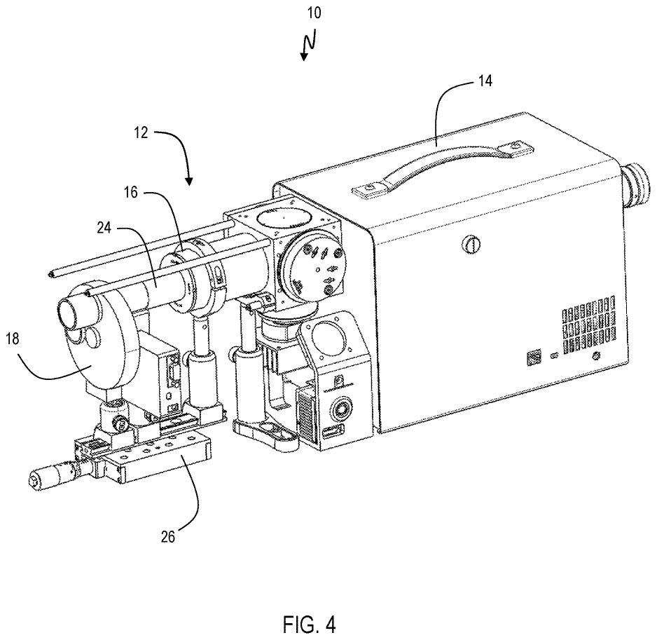

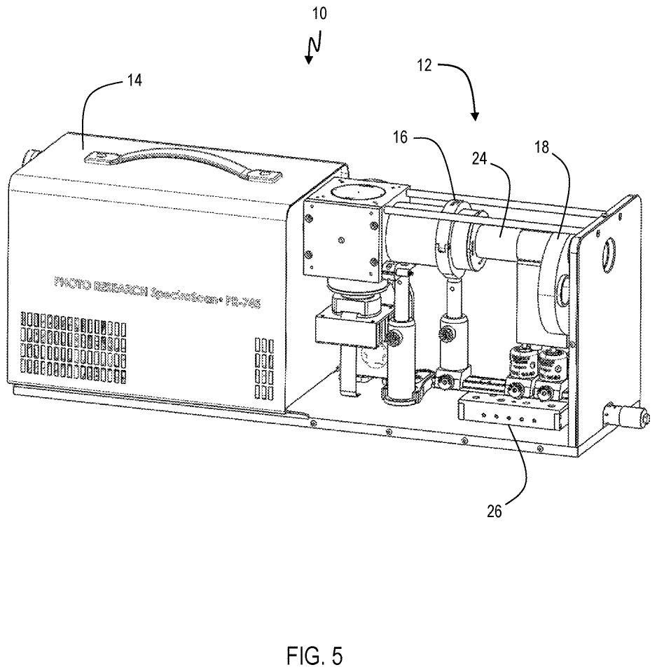

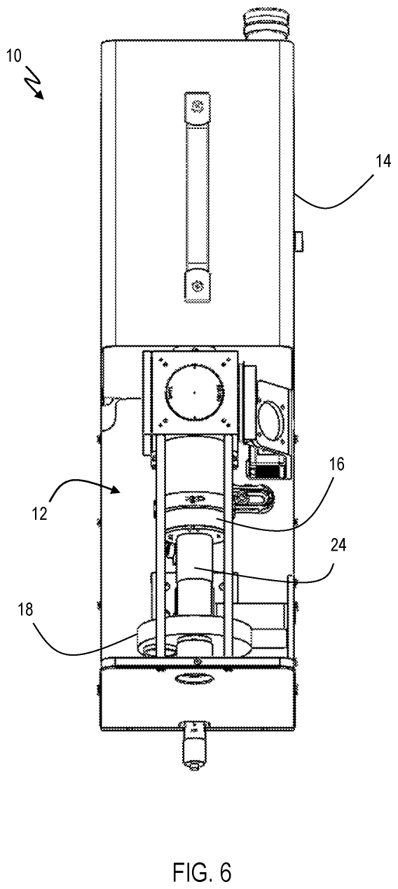

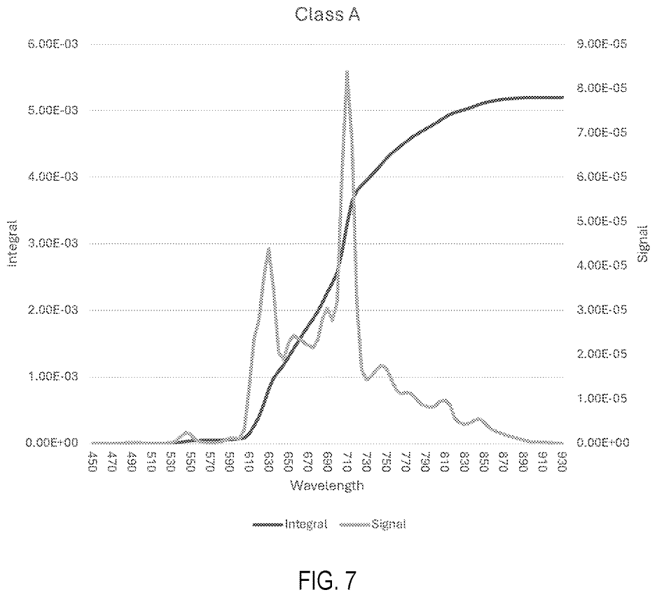

Referring to FIGS. 2 through 6, imaging imager 12 includes a lens turret 16 and a filter wheel 18 that can support original ND filters which span the range of the vision systems to be evaluated, such as Class A and Class B Night Vision Goggles (NVG). In addition, filter wheel 18 can be used to provide color filters. A sample high dynamic range measurement is seen in FIG. 7, where the NVIS Class A relative response is applied to input radiance with units of W/(m²-sr-nm).

Spectroradiometer 14 may comprise the SpectraScan® PR-745 spectral engine available from Novanta. As is known in the art, spectroradiometers are sophisticated colorimetric devices that capture true-to-life colors first measuring light intensity across different wavelengths in the electromagnetic spectrum and then applying a calculation (e.g. tristimulus values). Spectroradiometers are used to provide precise light and color calibration that is crucial for delivering consistent, high-quality images that uphold the integrity and performance of display systems.

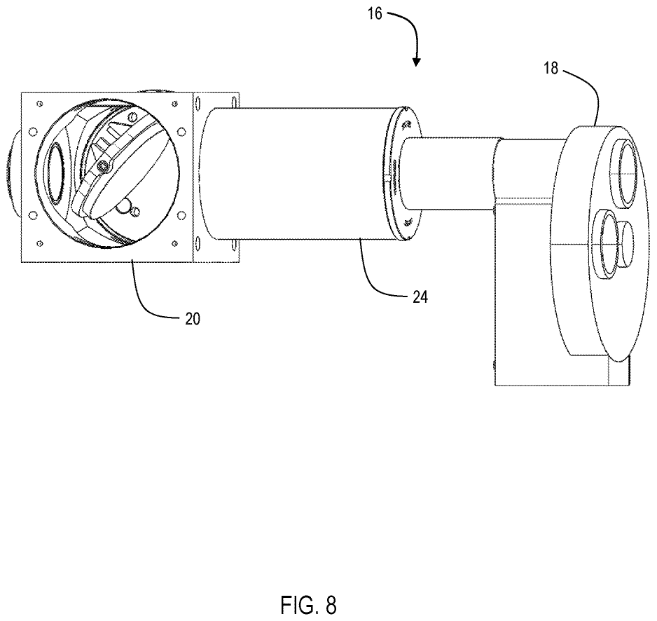

As further seen in FIG. 8, lens turret 16 of imaging imager 12 is aligned with a beamsplitter 20 so that an imaging assembly 22 positioned below beamsplitter 20 and receiving light from beamsplitter 20 can capture digital images of a target aligned along the optical path of lens turret 16. Beamsplitter 20 also directs incoming light traveling along the optical path of lens turret 16 to the input port of spectroradiometer 14, which is coupled adjacently to imaging imager 12. Lens turret 16 further comprises a lens assembly 24 and, along with filter wheel 18, that may be translated together by a linear stage 26 for focusing of the image and spectrum. Beamsplitter 20 thus allows for simultaneous imaging and measuring of spectral radiance. When used together, 2D spectral radiance measurements are made possible by spectral estimation and non-linear optimization methods. The beamsplitter ratio of beamsplitter 20 can also be adjusted from 20% R/80% T in 10% increments. Filter wheel 18 enables high dynamic range measurements, such as NVIS radiance, when installed with ND filters. When paired with color glass filters, filter wheel 18 also enables multispectral camera images with 6 or more channels rather than 3, as in the case of a conventional RGB camera.

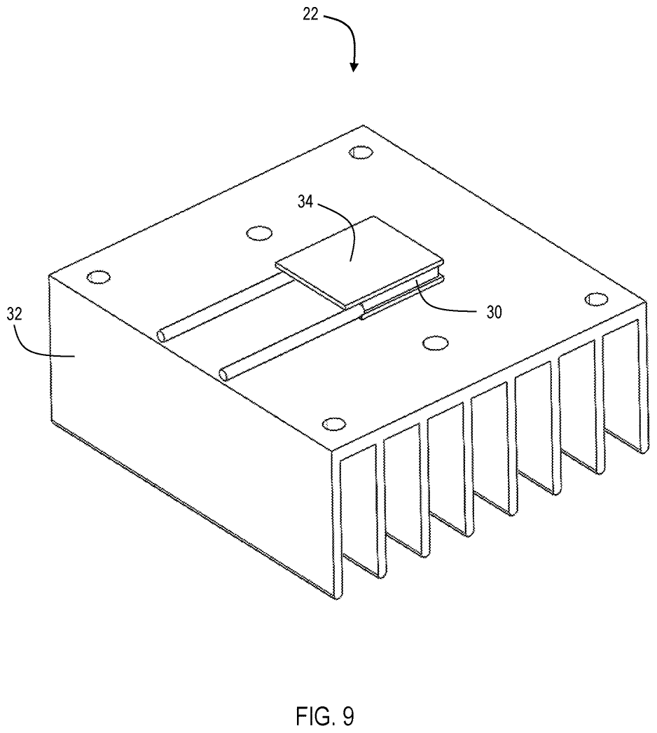

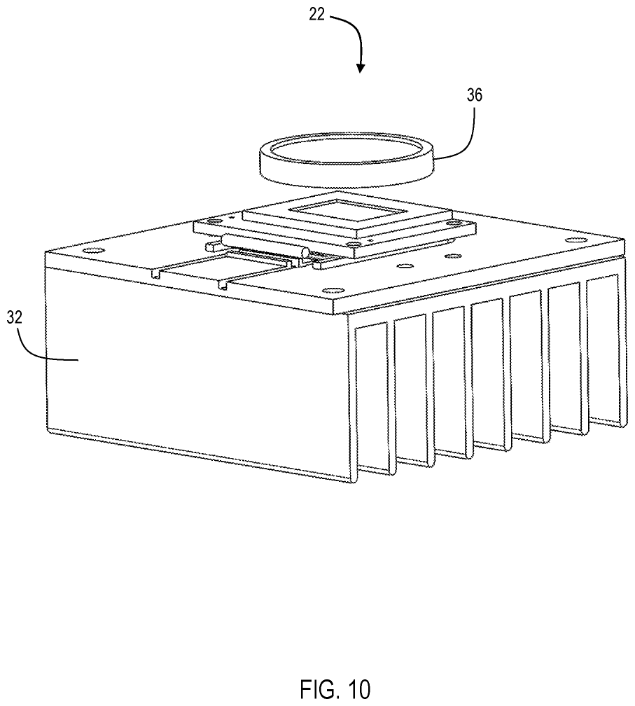

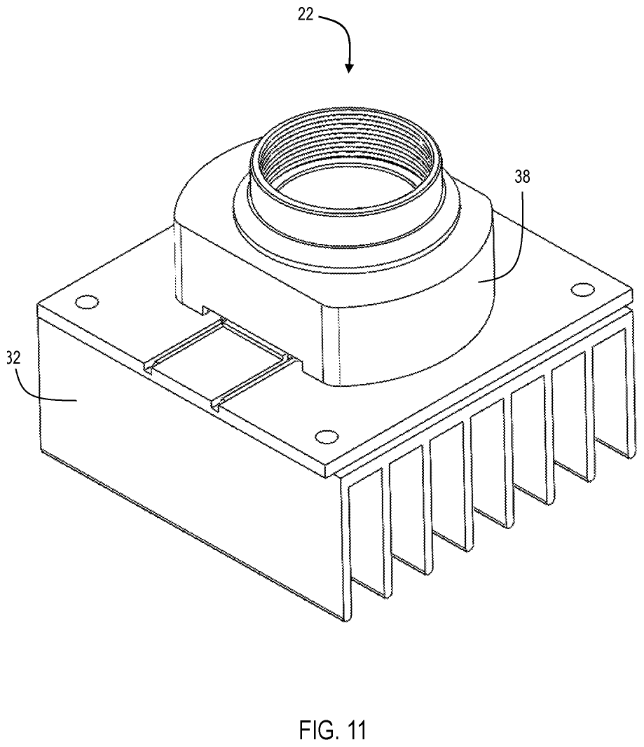

Referring to FIG. 9, imaging assembly 22 includes a thermoelectric cooler (TEC) 30 and heat sink 32 supporting and cooling a CMOS imager 34. As seen in FIG. 10, imaging assembly 22 further includes a photopic filter 36 and, as seen in FIG. 11, a housing 38 that is positioned over and encloses a monochrome CMOS imager 34 and photopic filter 36. Imager 34 may be an imaging colorimeter for RGB sensors by an RGB-to-XYZ transform to the tristimulus values. Without cooling, the junction temperature of the image sensor at room temperature will be approximately 45° C. during normal operation. With cooling applied via a thermoelectric cooler (TEC), heat sink, and retaining plate, the junction temperature can be cooled to below 8° C. at room temperature operation, which enables long exposure measurements beyond 2 minutes.

Imager 12 provides a wide range of working distances (2″-14″). Spectroradiometer 14 preferably includes NIST spectral stray light correction as well as wavelength calibration (<0.1 nm spectral accuracy) from 380-1080 nm and NIR enhanced sensitivity at 1080 nm. Device 10 can optimize the two detection methods provided by imager 12 and spectroradiometer 14. The imaging photometer pixels provided by CMOS imager 34 are much smaller than those of the spectroradiometer. Imager 12 and spectroradiometer 14 can be made similar, however, by binning the imaging photometer pixels to match the spectroradiometer pixels. As an example, there may be 7×7 imaging photometer pixels for every 1 pixel of the spectroradiometer.

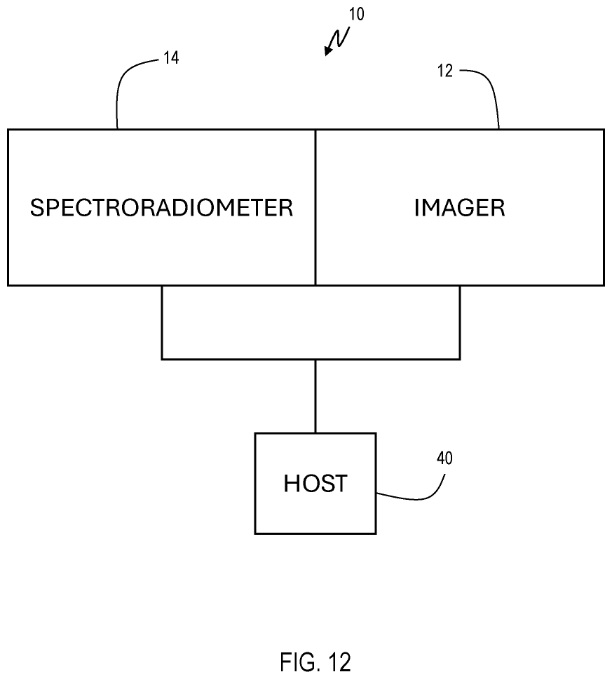

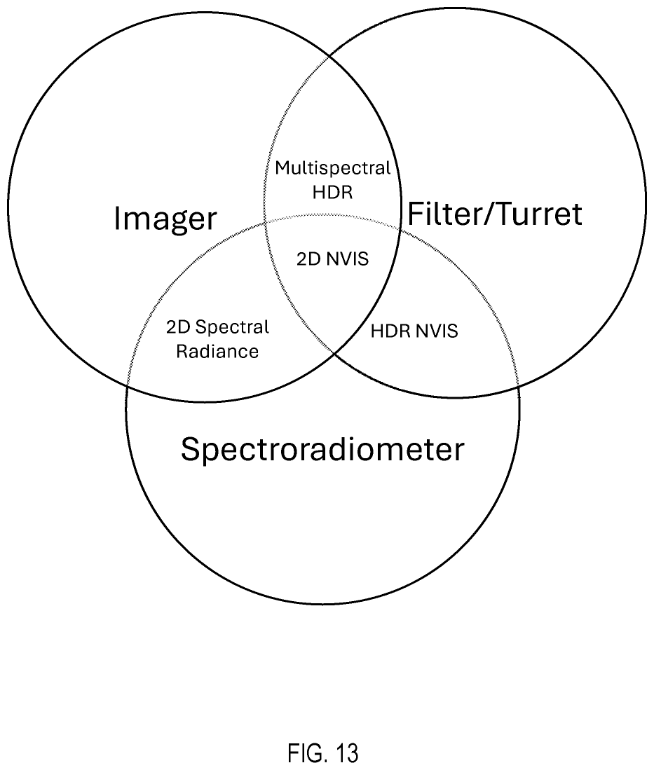

Referring to FIG. 12, the outputs from the imager 12 (photometric or colorimeter) and spectroradiometer 14 can be provided to a host device 40 programmed to control the instruments, receive the raw data, and provide further processing of the data for the various applications seen in FIG. 13. Spectroradiometer 14 and imager 12 may be controlled using a host application running on host device 40. For example, spectroradiometer 14 may be controlled using Spectra Win for manual data collection and export to CSV, Remote Mode to provide a command set using ASCII strings to automate the instrument (with Matlab and Python test scripts), or SDK to automate the instrument. Imager 12 may be controlled using Clarity Studio and Python 3.9.9.

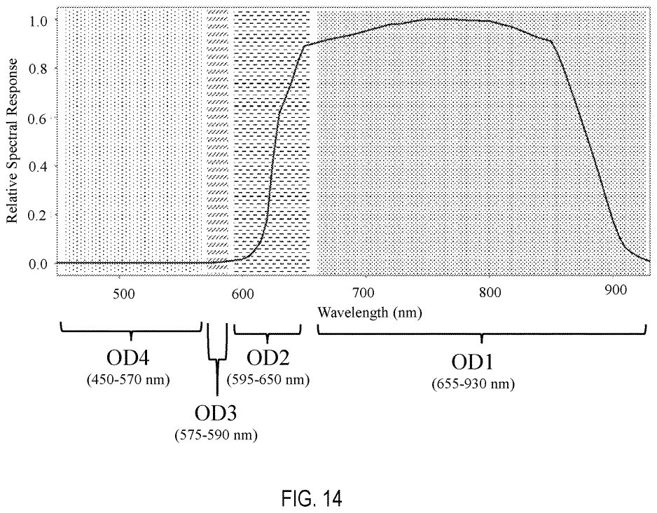

Referring to FIG. 14, the invention includes a method to measure NVIS radiance by segmenting the spectral range and applying different OD filters to each region based on intensity that can be implemented, for example, on device 10 of the present invention. The resulting spectra are normalized, stitched, and integrated to compute accurate NVIS radiance that complies with MIL-STD-3009. As seen in FIG. 14, the spectral range of 450-930 nm is divided into sub-ranges based on expected brightness. High-intensity regions (e.g., 450-570 nm) are captured using higher OD filters (e.g., OD4) to prevent saturation. Lower-intensity regions use lower OD filters (e.g., OD1-OD2) to enhance SNR. This approach maximizes signal-to-noise ratio in each band and avoids detector saturation in bright regions while preserving sensitivity in dimmer regions. The spectral data is captured in segments using a spectrometer, such as that included in device 10. Each segment is then normalized using its corresponding OD factor and the segments are stitched to reconstruct a full spectrum. The full spectrum may then be multiplied by the NVIS gain function GA(λ), per MIL-STD-3009. Integration over the NVIS band yields total NVIS radiance. In FIG. 14, the black Line represents the GA(λ) curve from MIL-STD-3009, representing the relative spectral sensitivity of Class A NVIS. The shaded regions represent, from left to right, OD4: 450-570 nm—high attenuation needed due to low NVIS sensitivity, (OD3): 575-590 nm—moderate attenuation, (OD2): 595-650 nm—lower attenuation, and (OD1): 655-930 nm—minimal attenuation, where NVIS sensitivity is highest.

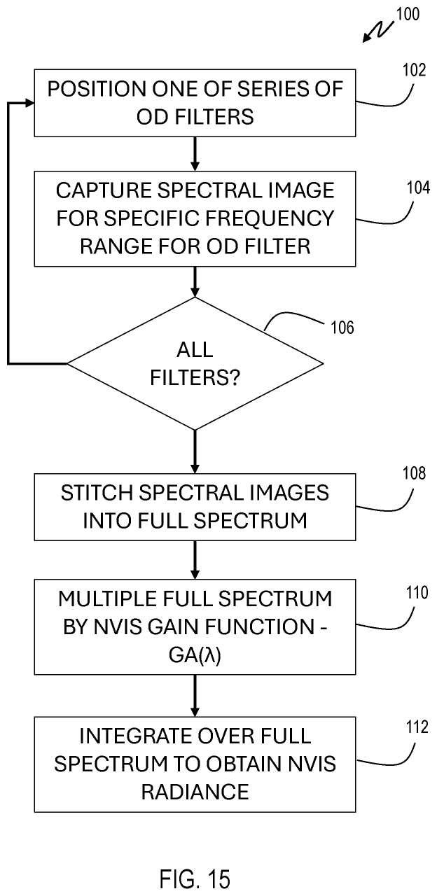

Referring to FIG. 15, device 10 may be programmed to perform a method 100 for determining NVIS radiance by first operating filter wheel 18 to sequentially position each of the filters to be used 102 and then capturing a spectral image of the discrete wavelength region for each OD filter 104, as identified in FIG. 14. For example, filter wheel 18 may be rotated to OD4 and then the spectral response measured for light having a wavelength of 450-570 nm. Next, filter wheel 18 is rotated to OD3 to measure 575-590 nm. Filter wheel 18 may then be rotated to continue with OD2/OD1 for longer wavelengths, e.g., 595-650 nm and 655-930 nm. If a check 106 determines that all filters have been used with the associated images captured 106, the spectral images from each wavelength region and corresponding OD filter may then be stitched together to provide the full spectrum 108. For example, the spectral images may be normalized using the known OD attenuation factor and then combining into a full spectrum for NVIS radiance calculation via stitching. The stitched spectrum may then be multiplied by the GA(λ) curve from the applicable standard 110, such as MIL-STD-3009, and then integrated to compute NVIS radiance 112. Even though OD filters are not spectrally selective, using each filter and the performing controlled, segmented measurements allows for tailoring of the dynamic range to the spectral power distribution of the source. The present method also allows for the preservation of linearity and accuracy across the full NVIS band (450-930 nm). Finally, the method maintains compatibility with MIL-STD-3009's radiometric methodology.

The operation of filter wheel 18 and the stitching may be accomplished locally via a processor or controller of device 10 or be exported to host 40 for processing according to the present method. As an example of an implementation on device 10, device 10 may include a measure button that, when pushed, will trigger device 10 to rotate filter wheel 18 to the first position and start capturing the measurements with existing parameters. Device 10 may then proceed through all needed positions automatically. When the final stage is finished, the NVIS radiance number may be displayed on device 10. Firmware associated with device 10 may store each individual measurement and be programmed to control filter wheel 18 to rotate to the appropriate positions.

The cut-off wavelengths for Class A & B are described in Table 1 and 2 below. The interval of NVIS spectrum is 5 nm so the firmware will pick data points at specific wavelengths from the set of measured spectrums. If a wavelength is not present, interpolation is needed.

TABLE 1
Cut-off wavelengths for Class B

| Start | Stop | |
|---|---|---|
| (nm) | (nm) | Class A |
| 450 | 570 | ND4 |
| 575 | 595 | ND3 |
| 600 | 615 | ND2 |
| 620 | 905 | ND1 |
| 910 | 930 | ND2 |

TABLE 2
Cut-off wavelengths for Class B

| Start | Stop | |
|---|---|---|
| (nm) | (nm) | Class B |
| 450 | 580 | ND5 |
| 585 | 605 | ND4 |
| 610 | 625 | ND3 |
| 630 | 645 | ND2 |
| 650 | 905 | ND1 |
| 910 | 930 | ND2 |

Host 40 may be programmed to receive measurement data from device 10 and then perform assembling of the set to form a NVIS spectrum and calculate/display the NVIS radiance. Host 40 may further be programmed to send setup parameters including the NVIS class setting to device 10 when the measure button is pressed and can additionally initiate measurement 4 or 5 times depending on the class setting, e.g., for class A, 4 measurements are necessary and for class B, 5 measurements are necessary. The measurement data and the results may also be stored by host device 40.

What is claimed is:

1. An optical calibration device, comprising:
a filter wheel supporting a plurality of filters;
a turret aligned with the filter wheel;
a beamsplitter aligned with the turret to direct any light received from the turret into a first path and a second path that is different than the first path;
an imaging assembly aligned with the first path to capture a digital image of any light in the first path; and
a spectroradiometer aligned with the second path to collect spectral measurements of any light in the second path.

2. The optical calibration device of claim 1, wherein the turret includes a lens assembly.

3. The optical calibration device of claim 2, wherein the plurality of filters of the filter wheel are selected from a set of neutral density filters, each of which has a different optical density.

4. The optical calibration device of claim 3, wherein the imaging assembly comprises a photopic filter aligned along the first path and an imager downstream of the photopic filter in the first path.

5. The optical calibration device of claim 4, wherein the imaging assembly further comprises a thermoelectric cooler and a heat sink coupled to the imager.

6. The optical calibration device of claim 5, further comprising a stage coupled to the turret and the filter wheel that is moveable to adjust a focus of the lens assembly of the turret.

7. The optical calibration device of claim 6, wherein the imaging assembly and the spectroradiometer are coupled to a host.

8. The optical calibration device of claim 7, wherein the host is configured to bin a plurality of pixels received from the imaging assembly to match each of any pixels received from the spectroradiometer.

9. A method of measuring radiance of a night vision imaging system (NVIS) device, comprising the steps of:
emitting light from an NVIS device;
filtering the light from the NVIS device with each of a series of filters, wherein each of the series of filters has a different optical density (OD) from the other filters of the series of filters;
capturing a series of spectra of the filtered light, wherein each of the spectra having one of a series of consecutive wavelength ranges corresponding with one of the series of filters;
stitching the series of spectra together to form a stitched spectrum reflecting a relative spectral response for the NVIS device across all of the series of consecutive wavelength ranges;
multiplying the stitched spectrum by a GA (2) curve; and
integrating the stitched spectrum after multiplying to provide a total NVIS radiance.

10. The method of claim 9, wherein the step of filtering the light emitted from the NVIS device with each of the series of filters comprises the step of sequentially advancing each of the series of filters to filter the light emitted from the NVIS device.

11. The method of claim 10, wherein the step of capturing the series of spectra comprises the step of capturing the spectra of the filtered light with a spectrometer when each of the series of filters is positioned between the NVIS device and the spectrometer.

12. The method of claim 11, wherein a turret containing a lens assembly is positioned between the NVIS device and the spectrometer.

13. The method of claim 12, wherein the turret and the series of filters may be translated between the NVIS device and the spectrometer to focus the filtered light.

14. The method of claim 13, wherein the turret and the series of filters are coupled to a stage that is moveable between the NVIS device and the spectrometer to focus the filtered light.

15. The method of claim 14, wherein the series of consecutive wavelength ranges span from 450 nanometers to 930 nanometers.

16. The method of claim 15, wherein each of the series of consecutive wavelength ranges is distinguished from the other of the series of consecutive wavelengths according to expected brightness.

17. The method of claim 16, wherein the series of filters include an OD1 filter, an OD2 filter, an OD3 filter, and an OD4 filter.

18. The method of claim 17, wherein the series of wavelength range include a first wavelength range of 450-570, a second wavelength range of 575-590 nm, a third wavelength range of 595-650 nm and a fourth wavelength range of 655-930 nm.

19. The method of claim 18, wherein the OD4 filter is used to filter the light emitted from the NVIS device when the first wavelength range is captured, the OD3 filter is used when the second wavelength range is captured, and the OD2 filter is used when the third wavelength range is captured, and the OD1 filter is used when the fourth wavelength range is captured.
